(19) United States
(12) Patent Application Publication
(10) Pub. No.: US 2011/0119570 A1
(43) Pub. Date: May 19, 2011

(54) AUTOMATED VARIABLE DIMENSION DIGITAL DOCUMENT ADVISOR

(75) Inventors: Frank Michael Goetz, Fairport, NY (US); John Oliver Walker, Rochester, NY (US); Barry Glynn Gombert, Rochester, NY (US)

(73) Assignee: XEROX CORPORATION, Norwalk, CT (US)

(21) Appl. No.: 12/621,054

(22) Filed: Nov. 18, 2009

(51) Int. Cl. G06F 17/00; H04W 4/12

(52) U.S. Cl. 715/202; 455/466

(57) ABSTRACT

A system for creating variable dimension digital documents. The system includes a computer processor and a computer readable medium operably connected to the computer processor and having at least one software module installed on the computer readable medium and containing instructions for operating the computer processor to perform a process. The process includes the steps of receiving a user defined goal for creating a variable dimension digital document, wherein the user defined goal includes at least one recipient, determining at least one document template based upon the user defined goal, determining a plurality of digital assets to include in the variable dimension digital document based upon the document template and the user defined goal, creating a plurality of data files representing the potential variable dimension digital documents, and producing a results set including the potential variable dimension digital documents.

### RELATED APPLICATION

This application is related to co-pending U.S. patent application Ser. No. ______(Attorney Docket No. 20081191-US-NP/121782.25001).

### BACKGROUND

The description below relates to an automated document advisor and, more specifically, to an automated document advisor for creating customized digital documents.

Advances in digital photography and other digital asset acquisition technologies have helped to drive rising sales in digital photo and digital asset products. For example, personalized photo greeting cards, photo books and photo calendars are becoming increasingly popular among consumers. A consumer can use their digital camera to take a family picture, and include the family picture on a variety of products. However, while digital asset acquisition has improved over time, many drawbacks and barriers preventing the average, or non-expert, user from easily creating variable digital assets or photo products still exist.

Drawbacks exist when an average user attempts to configure multiple versions of similar digital asset products. For example, a user may want to create a set of photo greeting cards for three separate recipients or recipient groups. Each group could have a personalized message, a common family photo, and an additional photo related to the recipient or recipient group. In this example, utilizing software tools currently available to a consumer, the user would have to create three unique photo greeting cards, one for each recipient, though the photo greeting cards are very similar in style and substance. Additionally, if the user wishes to print each card on a unique type or size of printable media, the complexity of the printing process increases again, resulting in additional potentially unique designs for the user to create. This may result in the user reducing the number of recipients or reducing the design to a generic design suitable for all recipients or recipient groups.

Although commercial alternatives exist, these alternatives are relatively expensive because they typically require professional printing equipment that may require a large amount of time or resources to run. For example, for each unique design, a different printer offset may be needed, along with a different set of printing plates to produce the photo and any other printed material included in the design.

### SUMMARY

The invention described in this document is not limited to the particular systems, methodologies or protocols described, as these may vary. The terminology used herein is for the purpose of describing particular embodiments only, and is not intended to limit the scope of the present disclosure.

As used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In one general respect, the embodiments disclose a system for creating variable dimension digital documents. The system includes a computer processor and a computer readable medium operably connected to the computer processor and having at least one software module installed on the computer readable medium and containing instructions for operating the computer processor to perform a process. The process includes the steps of receiving a user defined goal for creating a variable dimension digital document, wherein the user defined goal includes at least one recipient, determining at least one document template based upon the user defined goal, determining a plurality of digital assets to include in the variable dimension digital document based upon the document template and the user defined goal, creating a plurality of data files representing the potential variable dimension digital documents, and producing a results set including the potential variable dimension digital documents.

In another general respect, the embodiments disclose a system for creating variable dimension digital documents. The system includes a computer processor and a computer readable medium operably connected to the computer processor and having at least one software module installed on the computer readable medium and containing instructions for operating the computer processor to perform a process. The process includes receiving a user defined goal for creating a variable dimension digital document, wherein the user defined goal includes a plurality of recipients, determining at least one document template for each of the plurality of recipients based upon the user defined goal, determining a plurality of digital assets for each of the plurality of recipients to include in the variable dimension digital document based upon the document template and the user defined goal, creating a plurality of data files representing the potential variable dimension digital documents for each of the plurality of recipients, producing a results set including each of the pluralities of potential variable dimension

In another general respect, the embodiments disclose a method of creating variable dimension digital documents. The method includes the steps of receiving at a computer processor a user defined goal for creating a variable dimension digital document, wherein the user defined goal includes at least one recipient, determining by the computer processor at least one document template based upon the user defined goal and loading the at least one document template from a computer readable medium operably connected to the computer processor, determining by the computer processor a plurality of digital assets to include in the variable dimension digital document based upon the document template and the user defined goal and loading the plurality of digital assets from the computer readable medium, creating by the computer processor a plurality of data files representing the potential variable dimension digital documents, and producing by the computer processor a results set including the potential variable dimension digital documents and storing the results set on the computer readable medium.

### BRIEF DESCRIPTION OF THE DRAWINGS

Aspects, features, benefits and advantages of the present invention will be apparent with regard to the following description and accompanying drawings, of which:

FIG. 1 illustrates an exemplary system overview of an automated document advisor according to an embodiment;

FIG. 2 illustrate an exemplary system architecture for the automated document advisor as shown in FIG. 1 according to an embodiment;

FIG. 3 illustrates an exemplary ontology used to classify a digital asset by the automated document advisor as shown in FIG. 1 according to an embodiment;

FIG. 4 illustrates an exemplary process for creating a variable dimension digital document using the automated document advisor as shown in FIG. 1 according to an embodiment; and

FIG. 5 illustrates various embodiments of a computing device for implementing various methods and processes described herein.

### DETAILED DESCRIPTION

For purposes of the discussion below, a “document advisor” refers to an application configured to interact with various digital assets provided by a user to create a digital document or a variable dimension digital document.

A “variable dimension digital document” refers to a data file containing data representing a digital document, a digital document having content and structure mapped onto a contact information list, resulting in a personalized digital document.

A “digital asset” refers to a data file containing data representing a printable graphic, photo, template and/or image available for including in a variable dimension digital document.

A “recipient” refers to a single recipient or a group of recipients having a common classification such as co-workers or classmates.

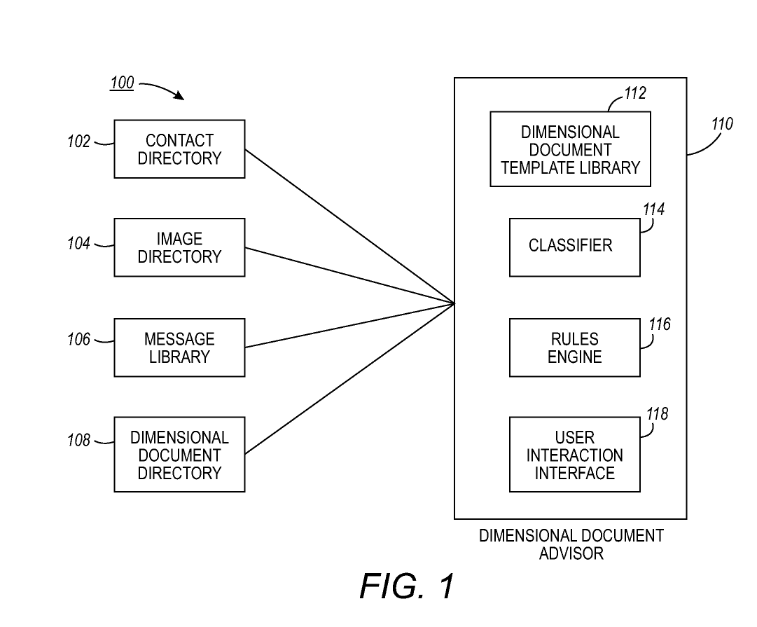

FIG. 1 illustrates an exemplary overview of an automated variable dimension document advisor system 100. The system 100 may include two major types of components or software modules, a series of user controlled or accessible components and a series of automated components. The user controlled or accessible components are shown on the left side of FIG. 1 and may include a contact directory 102, an image directory 104, a message library 106 and a dimensional document directory 108. The contact directory 102 may be a database, list, or other data structure stored in a computer readable memory that includes address contact information supplied by the user. For example, the contact directory 102 may include a user's Outlook® address book, Yahoo® address book, and other similar lists of contact information. The image directory 104 may include a collection of user created digital assets stored in a computer readable memory such as photos taken by the user. Additionally, the image directory 104 may include digital assets that the user is authorized or licensed to use, such as photos the user has purchased the right to use from a digital marketplace. The message library 106 may be a collection of files, a database or other data structure stored on a computer readable memory that includes various messages or greetings. The messages and greetings may be arranged and classified according to various identifiers such as by occasion (e.g., holidays or celebrations). The dimensional document directory 108 may be a folder or specific location in a computer readable memory where previously created variable dimension digital documents may be stored for access by the user at a later time.

Each of the user controlled or accessible components may be in communication with the dimensional document advisor 110. It should be noted that the dimensional document advisor 110 may be a standalone software application running on the user's computer locally, or a software application stored remotely on a server and accessed by the user via a network connection. The dimensional document advisor 110 may be a collection of automated components or software modules configured to function in concert with the user controlled or accessible components to produce a variable dimension digital document. The dimensional document advisor 110 may include various automated components such as a dimensional document template library 112, a classifier 114, a rules engine 116, and a user interaction interface 118. The dimensional document template library 112 may include a set of variable dimension digital document templates. For example, the templates may include a greeting card, a pop-up greeting card, a large gift-box, a small gift-box, and other similar templates. The classifier 114 may include a software module configured to create a hierarchy of classifications for various images, structural documents and contacts. Additionally, the classifier 114 may group contacts into recipient groups having a similar classification title, such as co-workers or classmates. The classifications may be used in various interactions with the user as well as by the rules engine 116 to produce variable dimension digital documents. The rules engine 116 may contain a listing of rules (e.g., structural document constraints), system facts (available images, structural document types, available contacts) and object relationships used to construct variable dimension digital documents. The user interaction interface 118 may be configured to acquire input and directions from the user as well as present results to the user once a digital document has been produced. The overall interaction of the components of system 100 is further explained in the following two exemplary use cases.

In the first exemplary use case, a user may configure the system 100 for their specific settings. During configuration, the user may configure the user controllable or accessible components (i.e., the contact directory 102, the image directory 104, the message library 106 and the dimensional document directory 108) to communicate with the dimensional document advisor 110. During configuration, the dimensional document advisor 110 may prompt the user to specify any contact lists, a local image directory, and the location in which the user wishes to store any created documents. After this information is provided, the dimensional

In the second use case, the system 100 may help a user to create a variable dimension digital document. In this use case, there may be two types of documents created, a first document created for a single recipient and a second document created for distribution to multiple recipients. In creating the first document, the user may first initialize the dimensional document advisor 110. The user may select an option to create a simple document intended for a single recipient. The dimensional document advisor 110 may interact with the user controllable or accessible components to acquire various digital assets such as descriptions of an intended recipient, a type of dimensional document to create, any appropriate or selected images, and any textual content to include. The dimensional document advisor 110 may analyze the assets to identify potential variable dimension digital document templates that correspond to the digital assets selected by the user. Using the acquired assets and identified templates, the dimensional document advisor 110 may create various variable dimension digital document samples that meet all criteria selected by the user. The dimensional document advisor 110 may return a set of thumbnail pictures to the user for closer inspection, as well as indicate which documents may require additional information.

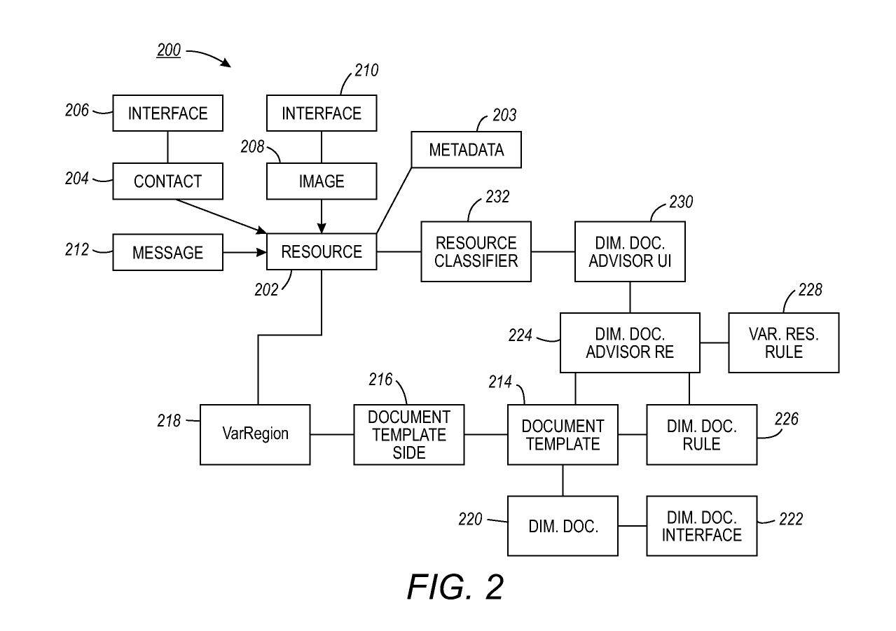

Creating the second type of document, one intended for multiple recipients, is similar to the first document creation with a few exceptions. In creating a document for multiple recipients, a user may select an option to create a complex document intended for multiple recipients. As before, the dimensional document advisor 110 interacts with the user controllable or accessible components to acquire various digital assets. However, in this example, there may be varied digital assets for each intended recipient. For example, a first recipient may have a first image, a first textual message, and a first variable dimension digital document template. A second recipient may have the first image, the first textual message, but a second variable dimension digital document template. And a third recipient may have a second image, a second textual message, and the second variable dimension document template. As before, once the dimensional document advisor 110 acquires the digital assets for each recipient, the dimensional document advisor may determine and rank various options from which the user selects options for a recipient, illustrated as various thumbnail images. The user may then review and select from the thumbnail images. This process repeats for each intended recipient of the variable dimension digital document. Once the creation and review process is completed, the overall results may be merged into a single set of results for additional consideration by the user. The overall functionality of the dimensional document advisor 110 as well as the creation process is explained in more detail in the discussions of FIGS. 2, 3 and 4 below.

FIG. 2 illustrates an exemplary architecture 200 of the various components and resources that may be utilized by the dimensional document advisor 110 as discussed above to configure a digital asset or resource 202 for use in a variable dimension digital document. Each resource 202 may have associated metadata 203 such as various properties and values associated with the resource, such as height, width, and location. Each resource 202 may be loaded as discussed above or input by the user. For example, if the resource 202 is a contact 204, the contact may be loaded from the contact directory via a contact directory interface 206. Similarly, if resource 202 is an image 208, the image may be loaded from the image directory via image directory interface 210. If the resource 202 is a text message 212, the message may be entered directly by the user or loaded from a directory of text messages.

A document template 214 may be a data file containing date that represents a structural template used to create a document (e.g., greeting card, pop-up greeting card). The document template 214 may include one or more template sides 216. Each template side 216 may include one or more variable regions 218, each of which may be associated with a resource 202. Each variable region 218 may be a defined space where a digital asset may be placed into the template. Based upon various limitations of the variable regions 218, such as size and location, the resource 202 may need to be altered. For example, if an image size is larger than the available size for a variable region, the image may need to be resized. Various types of assets may be placed in the variable regions 218 of the document template 214 according to a user defined goal. For example, if the user defined goal is to create a greeting card for a holiday, a greeting card document template 214 may be selected. This document template 214 may include four sides 216, each side having a varying number of variable regions 218. A combination of various resources 202 may be placed into the variable regions 218 according to various rules defined by the user defined goal. Once a document template 214 is populated with resources, it may be output as a variable dimension digital document 220 via a variable dimensional digital document interface 222.

A dimensional document advisor rules engine 224 may function to implement a specific rule used in the creation of a variable dimension digital document. The rules engine 224 may be a software module included on a computer readable memory, may be included in firmware, or may be a hardware circuit configured to perform a series of comparison operations. The rules engine 224 may load one or more rules from memory depending on the template being used to create the variable dimension digital document. The rules may contain geometrical information, such as any boundaries associated with the document, as well as other potential constraints relevant to the design of the document, such as whether the document will be cut or folded after printing. A document template specific rule 226 may define various aspects of the selected document template 214, while a variable resource rule 228 may define rules specific to individual resources used such as image or text size. The dimensional document advisor may communicate with a user via a user interface 230. The user interface may interact with the user controllable or accessible components as well as a resource classifier 232 to determine any metadata 203 of a resource 202 to be used.

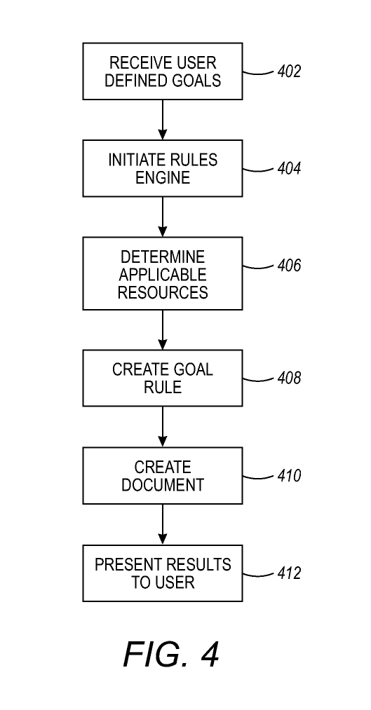

The rules engine 224 may be configured such that the rules engine compares objects or facts about the resources, and, if the comparison produces a positive result, the rules engine instructs the dimensional digital document advisor to take an action. For example, the dimensional document rule 226 may include rules specific to the selected dimensional document template 214 such as boundaries. The dimensional document template may have several property types suitable for matching by the rules engine such as location of variable regions 218 for placing a resource 202. Similarly, rules engine 224 may consider user defined goals such as characteristics of the variable dimension digital document to create, as well as characteristics of the digital assets or resources to include. The function of the rules engine 224 is explained in more detail below in the discussion of FIG. 4.

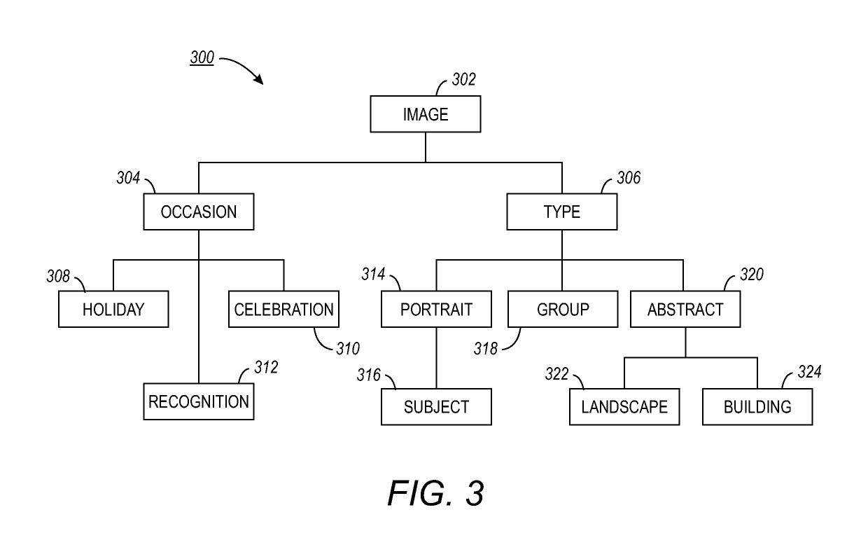

FIG. 3 illustrates a sample ontology 300 that may be used in classifying various digital assets or resources. In this example, an image 302 may be classified according to various categories, such as an occasion 304 and a type 306. The various criteria may have even more specific sub-categories such as sub-categories a holiday 308, a celebration 310, and a recognition 312 associated with occasion 304. Similarly, the type 306 may have sub-categories, such as a portrait 314, a group 318 and an abstract 320. Sub-categories may have further sub-categories such as a subject 316 (a sub-category of the portrait 314) and a landscape 322 and a building 324 (sub-categories of the abstract 320). During classification, each image may be classified according to the ontology 300 or another similar ontology. It should be noted that an image may belong to one or more categories and/or sub-categories, and the titles for the categories and sub-categories shown herein are used by way of example only. Similar ontologies may be used to classify messages and templates, however, each separate ontology may have specific categories and sub-categories. As such, each type of asset or resource is classified by an asset-type specific ontology.

FIG. 4 shows a flowchart illustrating an exemplary process for creating a variable dimension digital document using the dimensional document advisor discussed herein. The process may initiate when a user defines a set of goals at a user interface associated with the dimensional document advisor, and the dimensional document advisor receives 402 these goals. For example, a user may indicate their intention to create a pop-up greeting card for contact “Mary”, potentially including images associated with “Mary” and “Cooking”, the card to include the message “Happy Birthday!” Once these goals are received 402, the dimensional document advisor may initiate 404 the rules engine. The dimensional document advisor may also determine 406 any available and applicable resources to be used in the creation of the variable dimension digital document. For example, the image directory may be searched for any images having the classification “Mary” and “Cooking,” and the template directory may be searched for any pop-up greeting card templates. Based upon the available resources, the dimensional document advisor may create 408 a corresponding goal rule to be used during the creation of the pop-up greeting card. Based upon the goal rule and the available resources, the dimensional document advisor creates 410 a variable dimension digital document result set. This result set may be presented 412 to the user for review and selection. The results set may be stored on a computer readable memory for access by a user at a later time, displayed on a computer display for the user to immediately review, sent to a user in an email message or provided as a downloadable file. During review, the user may chose to physically create one or more of the variable dimension digital documents provided in the results set by sending individual data files representing the variable dimension digital document to a printing device such as a desktop ink-jet or laser printer. The user may also select individual data files to be sent to a commercial or professional printing service for printing. The finished products may then be mailed to the user.

As discussed above, for multiple recipients, the process is similar, however, the determination 406 and the creation 410 is repeated for each recipient.

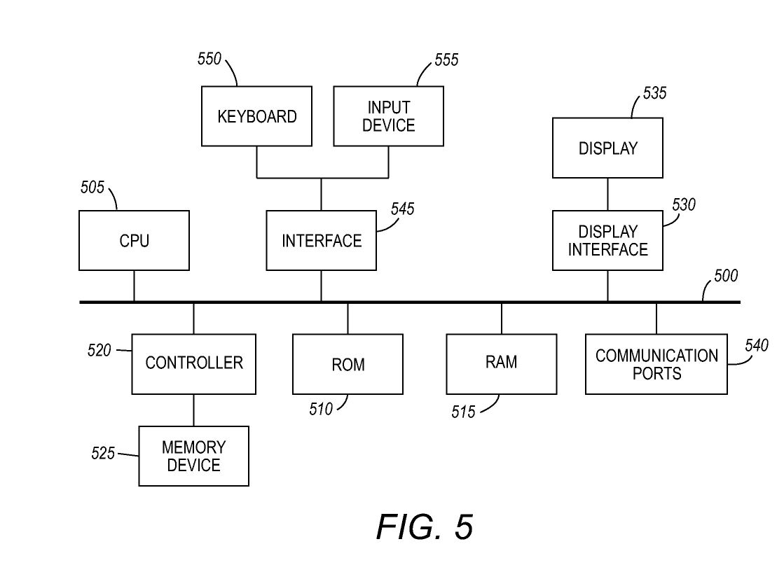

The automated variable dimension document advisor as described above may be presented on a display based on software modules including computer-readable instructions that are stored on a computer readable medium such as a hard drive, disk, memory card, USB drive, or other recording medium. FIG. 5 depicts a block diagram of exemplary internal hardware that may be used to contain or implement program instructions such as the software architecture discussed above in reference to FIG. 2. A bus 500 serves as the main information highway interconnecting the other illustrated components of the hardware. CPU 505 is the central processing unit of the system, performing calculations and logic operations required to execute a program. Read only memory (ROM) 510 and random access memory (RAM) 515 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions may be stored in the ROM 510 and/or the RAM 515. Optionally, program instructions may be stored on a tangible computer readable medium such as a compact disk, a digital disk, flash memory, a memory card, a USB drive, an optical disc storage medium, such as Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for creating variable dimension digital documents comprising:
a computer processor; and
a computer readable medium operably connected to the computer processor and having at least one software module installed on the computer readable medium and containing instructions for operating the computer processor to perform a process, the process comprising:
receiving a user defined goal for creating a variable dimension digital document,
wherein the user defined goal includes at least one recipient,
determining at least one document template based upon the user defined goal,
determining a plurality of digital assets to include in the variable dimension digital document based upon the document template and the user defined goal,
creating a plurality of data files representing the potential variable dimension digital documents, and
producing a results set including the potential variable dimension digital documents.

2. The system of claim 1, wherein the plurality of digital assets comprise data files representing various images and text messages.

3. The system of claim 1, wherein the plurality of digital assets include associated metadata, the metadata comprising classification information determined according to an asset-type specific ontology.

4. The system of claim 1, wherein the user defined goal includes a plurality of recipients.

5. The system of claim 4, wherein the at least one document template comprises at least one document template for each of the plurality of recipients.

6. The system of claim 4, wherein the plurality of digital assets comprises at least one digital asset for each of the plurality of recipients.

7. The system of claim 4, wherein the plurality of potential variable dimension digital documents comprises at least one potential variable dimension digital document for each of the plurality of recipients.

8. The system of claim 1, wherein the user defined goal further comprises a type of digital asset to include and a type of document template to use.

9. A system for creating variable dimension digital documents comprising:
a computer processor; and
a computer readable medium operably connected to the computer processor and having at least one software module installed on the computer readable medium and containing instructions for operating the computer processor to perform a process, the process comprising:
receiving a user defined goal for creating a variable dimension digital document,
wherein the user defined goal includes a plurality of recipients,
determining at least one document template for each of the plurality of recipients based upon the user defined goal,
determining a plurality of digital assets for each of the plurality of recipients to include in the variable dimension digital document based upon the document template and the user defined goal,
creating a plurality of data files representing the potential variable dimension digital documents for each of the plurality of recipients,
producing a results set including each of the pluralities of potential variable dimension digital documents created for each of the plurality of recipients, and
presenting the results set to a user for review.

10. The system of claim 9, wherein the plurality of digital assets include data files representing various images and text messages.

11. The system of claim 9, wherein the plurality of digital assets include associated metadata, the metadata comprising classification information determined according to an asset-type specific ontology.

12. The system of claim 9, wherein the user defined goal further comprises a type of digital asset to include and a type of document template to use.

13. A method of creating variable dimension digital documents comprising:
receiving at a computer processor a user defined goal for creating a variable dimension digital document, wherein the user defined goal includes at least one recipient;
determining by the computer processor at least one document template based upon the user defined goal and loading the at least one document template from a computer readable medium operably connected to the computer processor;
determining by the computer processor a plurality of digital assets to include in the variable dimension digital document based upon the document template and the user defined goal and loading the plurality of digital assets from the computer readable medium;
creating by the computer processor a plurality of data files representing the potential variable dimension digital documents; and
producing by the computer processor a results set including the potential variable dimension digital documents and storing the results set on the computer readable medium.

14. The method of claim 13, wherein the plurality of digital assets include associated metadata, the metadata comprising classification information determined according to an asset-type specific ontology.

15. The method of claim 13, wherein the user defined goal includes a plurality of recipients.

16. The method of claim 15, wherein the at least one document template comprises at least one document template for each of the plurality of recipients.

17. The method of claim 15, wherein the plurality of digital assets comprises at least one digital asset for each of the plurality of recipients.

18. The method of claim 15, wherein the plurality of potential variable dimension digital documents comprises at least one potential variable dimension digital document for each of the plurality of recipients.

19. The method of claim 13, wherein the user defined goal further comprises a type of digital asset to include and a type of document template to use.
